(19) United States
(12) Patent Application Publication
(10) Pub. No.: US 2012/0256465 A1
(43) Pub. Date: Oct. 11, 2012

(54) MOTOR VEHICLE SEAT CROSSMEMBER

(75) Inventors: Guido Lilla, Drolshagen (DE); Fred Böhm, Erkrath (DE)

(73) Assignee: Thiel & Hoche GmbH & Co. KG, Erkrath (DE)

(21) Appl. No.: 13/443,929

(22) Filed: Apr. 11, 2012

(30) Foreign Application Priority Data
Apr. 11, 2011 (DE) 10 2011 007 129.6

(51) Int. Cl. B60N 2/68

(52) U.S. Cl. 297/452.2

(57) ABSTRACT

The invention relates to a motor vehicle seat crossmember comprising:
a tubular base body and
receptacle section arranged on the base body for the torsion-free arrangement of a coupling element.
   In order to provide a motor vehicle seat cross-section that can be economically produced and that has a low weight and a high strength, it is provided that the receptacle section has a reinforcing tube that is arranged coaxial to the base body and lies on its inner or outer surface, and a cross-section deviating from a circle that is produced by joint deformation, especially cold formation, of the base body and the reinforcing tube.

### BACKGROUND OF THE INVENTION

1. Field of the Invention

The invention relates to a motor vehicle seat crossmember comprising:
a tubular base body, and
a receptacle section arranged on the base body for the torsion-free arrangement of a coupling element.

2. Description of Related Art

Motor vehicle crossmembers of the aforementioned type are used in a variety of embodiments in the construction of motor vehicle seats, and they extend transversally to the vehicle direction of the seat, especially the seat base frame, with reference to the installation position of the motor vehicle seat in the motor vehicle. In a typical embodiment, the motor vehicle seat crossmember extends between the side parts of a motor vehicle seat and serves to non-rotatably accommodate suitable levers that enable the motor vehicle seat to be adjusted, such as in height, wherein the motor vehicle seat crossmember is connected in a pivotable manner to the side parts of a motor vehicle seat.

The reliable transmission of torque from the lever to the tubular base body is essential to the functioning of the motor vehicle seat crossmember, especially when used as a mount for a lever. Normally, for this tubular bodies are used that offer sufficient strength arising from their dimensions and/or the selected material. However, in order to accommodate the increased demands of vehicle manufacturers relating to reduced weight and installation space, involved production methods have become necessary, and/or very strong materials need to be used to allow motor vehicle seat crossmembers to be manufactured with the desired properties. However, this yields high production costs which cumulatively cause the motor vehicle seat to be more expensive.

### BRIEF SUMMARY OF THE INVENTION

The object of the invention is to offer a motor vehicle crossmember that can be manufactured economically and that has a low weight and a high strength.

The invention achieves this object with a motor vehicle seat crossmember having the features of claim 1. Advantageous embodiments are described in the dependent claims.

It is characteristic of the motor vehicle seat crossmember according to the invention that the receptacle section at which a coupling element is arranged on the base body of the motor vehicle seat crossmember, for example a lever connected to the motor vehicle seat crossmember, has a reinforcing tube arranged coaxial to the base body and lying on the inner or outer surface of the base body, wherein the receptacle section is manufactured by joint deformation, especially cold formation of the base body and the reinforcing tube, thereby having a cross-section deviating from a circle.

According to the invention, the reinforcing tube only extends over a section of the base body, that is, in the area in which the motor vehicle seat crossmember is connected to a coupling element such as a lever. To guarantee a torsion-free connection of the coupling element to the motor vehicle seat crossmember, the reinforcing tube and base body are shaped jointly by deformation, especially cold formation, to create a corresponding receptacle section having a cross-section that deviates from a circle so that the coupling element can be connected to the motor vehicle seat crossmember in a keyed fit, wherefore a receptacle opening of the coupling element is adapted to the cross-section of the receptacle section.

The use of a reinforcing tube that stabilizes the base body and extends only over a section of the base body guarantees a torque-free connection between the coupling element and the motor vehicle seat crossmember. Torque introduced by the coupling element such as a lever is reliably transmitted to the vehicle seat crossmember without the coupling element tearing out of or twisting in the receptacle section, and especially when there is an advantageous arrangement of two or more coupling elements such as levers, the transmission of torque between these coupling elements is particularly suitable in the extension section of an extension tube.

According to the invention, the motor vehicle seat crossmember can hence be produced in the stable manner required by manufacturers, and the vehicle crossmember also has a low intrinsic weight since the base body is only partially reinforced. Furthermore, by using a reinforcing tube, high-strength materials do not have to be used also for small base bodies with small diameters and wall thicknesses; instead, economical materials can be used for the base body. The reinforcing tube extends over a section of the base body that is dictated by structural requirements and can also be made of economical standard materials. The base body and reinforcing tube are jointly formed in an economical manner, especially by cold forming.

The design of the receptacle section for arranging a coupling element in a torsion-free manner is freely selectable. It can for example have an elliptical cross-section to ensure a sufficient transmission of torque. In a particularly advantageous embodiment of the invention, the receptacle section has however a polygonal, e.g. hexagonal cross-section. A correspondingly designed receptacle section can be manufactured particularly easily and economically by jointly forming the reinforcing tube and base body, and allows a particularly reliable, torsion-free arrangement of the lever which can also be economically designed with a correspondingly designed receptacle opening.

The coupling element only has to be plugged onto the receptacle section to be arranged, wherein the receptacle section can also be designed depending on the receptacle opening of the coupling element to create a friction lock when shoved on. According to a particularly advantageous embodiment of the invention, the receptacle section can have a shape that tapers for arranging the coupling element, wherein the cross-section of the receptacle section decreases in a particularly advantageous manner opposite the direction in which the coupling element is shoved onto the receptacle section. A correspondingly designed receptacle section in which the tapering can be realized by a stepped contour of the cross-section of the receptacle section toward the ends of the motor vehicle seat crossmember, as well as by a continuously tapering cross-section makes the coupling element particularly easy to install due to the initial difference in the diameters of the receptacle opening and receptacle section. At the same time, the decreasing difference in diameter in the shove-on direction yields a stable, keyed arrangement on the receptacle section, the coupling element having a correspondingly designed receptacle opening.

The reinforcing tube can be arranged in any desired manner on the base body, wherein an arrangement on an outside surface of the base body is also possible. According to a particularly advantageous embodiment of the invention, the reinforcing tube is however arranged inside the base body, preferably in the area of one end of the base body. A corresponding embodiment prevents the diameter of the motor vehicle seat crossmember from being increased in the area of the reinforcing tube. This can be inserted in a particularly easy manner by being shoved into one end of the base body and shaped by joint deformation, especially cold formation, together with the base body to form the receptacle section. The reinforcing tube is adapted to the base body so that the reinforcing tube can be inserted into the base body with a tight fit.

The reinforcing tube is connected to the base body in a particularly reliable manner in a secured position by forming the reinforcing tube with the base body to produce the receptacle section. According to a particularly advantageous embodiment of the invention it is further provided that the base body and reinforcing tube are additionally formed jointly, especially cold-formed, in an area of the base body different from the receptacle section to create a tapering. The tapering at which the motor vehicle seat crossmember has a diameter less than the neighboring areas of the motor vehicle seat crossmember, such as a peripheral groove or a peripheral recess having a polygonal cross-section, secures the position of the reinforcing tube on the base body in a particularly reliable manner. This prevents the reinforcing tube from shifting axially in relation to the base body in a particularly reliable manner. In one embodiment of the tapering that corresponds to the cross-section of the receptacle section, the tool used to create the receptacle section can also be economically used to create the tapering.

The reinforcing tube primarily serves to partially reinforce the base body in the area of the coupling element to be arranged, and thereby to design the receptacle section. In addition, the reinforcing tube can also fulfill other functions. Hence according to an advantageous development of the invention, the reinforcing tube is designed to arrange one end of a torsion bar spring arranged within the base body in a torsion-free manner. A torsion bar spring that is employed in the area of the motor vehicle seat to support seat adjusting movements and must be fixed at both ends can have one end fixed to the correspondingly designed reinforcing tube in this embodiment of the invention, thus rendering additional fasteners unnecessary which reduces the corresponding installation effort.

It is particularly advantageous for the reinforcing tube to have a funnel-shaped receptacle opening for arranging one end of the torsion bar spring which allows a further simplification of installation, thereby enabling the reduction of the production costs of a motor vehicle seat which is produced using a correspondingly designed motor vehicle seat crossmember.

The connection between the base body and reinforcing tube is already ensured by the deformation, especially cold formation, to produce the receptacle section. According to one particularly advantageous embodiment of the invention, the reinforcing tube and base body however are also integrally bonded to each other, especially welded to each other, for example by spiral laser welding. By means of a corresponding embodiment in which the base body and reinforcing tube can also be adhered, the position of the reinforcing tube is additionally secured to the base body to prevent the reinforcing tube from rotating in relation to the base body in a particularly reliable manner.

As mentioned above, the reinforcing tube can also fulfill additional functions in addition to its contribution in forming the receptacle section. Thus, according to another embodiment of the invention, the reinforcing tube has a bearing section that extends beyond the end of the base body in an installed state and has a diameter up to 50% less than the base body as a result of the deformation, especially cold formation, of the reinforcing tube.

According to this embodiment of the invention, a section of the reinforcing tube extending out of the base body serves to bear the motor vehicle seat crossmember on a suitable vehicle seat component. The use of a corresponding reinforcing tube allows the tube to be designed with sections having a diameter up to 50% less than the base body. This makes it possible for the bearing receptacle to be provided at the motor vehicle seat to also have a smaller design which reduces structural weaknesses. Before being installed on the base body, the reinforcing tube can be provided with a bearing section with a correspondingly reduced diameter, thus rendering extensive reworking unnecessary.

The number of reinforcing tubes to be arranged on the base body is generally freely selectable corresponding to the required receptacle sections. It is however particularly preferably provided to arrange one, preferably two, reinforcing tubes in the area of each end of the base body. This allows a motor vehicle seat crossmember to be manufactured with two receptacle sections for a variety of uses that satisfies a majority of the requirements for the area of the motor vehicle seat.

According to another embodiment of the invention, a reinforcing tube designed to receive one end of a torsion bar spring is arranged in the area of a first end of the base body, and a reinforcing tube with a bearing section extending beyond the end of the base body is arranged in the area of a second end of the base body. According to this embodiment of the invention, the reinforcing tube arranged in the area of the first end, in addition to forming the receptacle section, serves to position a torsion bar spring that extends within the motor vehicle seat crossmember, and its opposite end extends out of the base body and the reinforcing tube arranged in the area of the second end. A correspondingly designed motor vehicle seat crossmember can be manufactured very easily and economically, and also allows a torsion bar spring that can be used for the motor vehicle seat to be securely connected.

### BRIEF DESCRIPTION OF THE SEVERAL VIEWS OF THE DRAWINGS

An exemplary embodiment of the invention is explained in the following in more detail with reference to the drawings. The drawings show:

FIG. 1 A perspective view of a motor vehicle seat crossmember with levers arranged thereupon;

FIG. 2 A perspective view of a section along the lengthwise axis of the motor vehicle seat crossmember from FIG. 1;

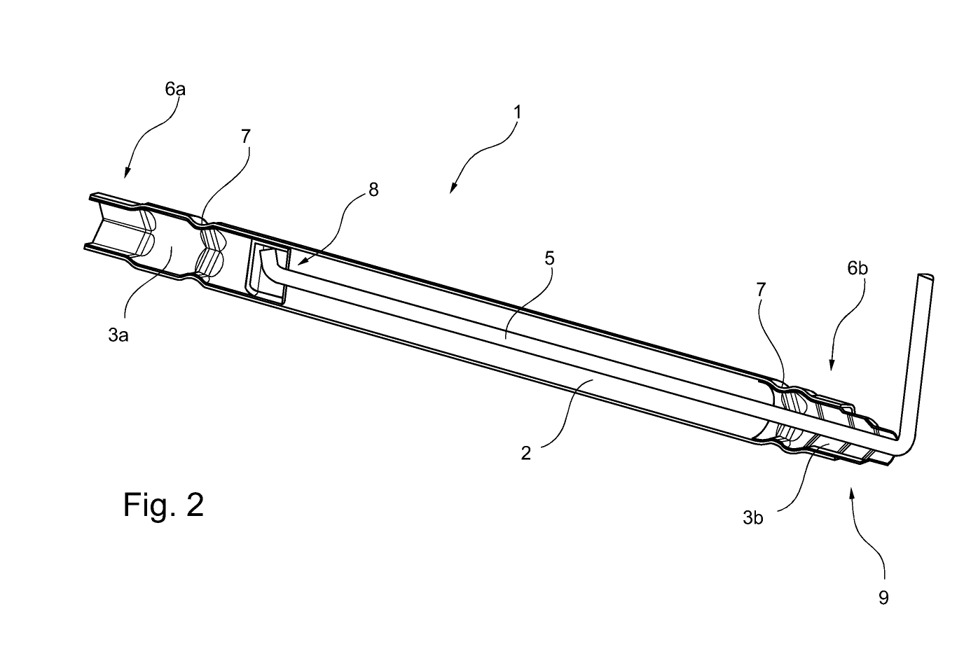

FIG. 3 A perspective view of a base body of the motor vehicle seat crossmember from FIG. 1;

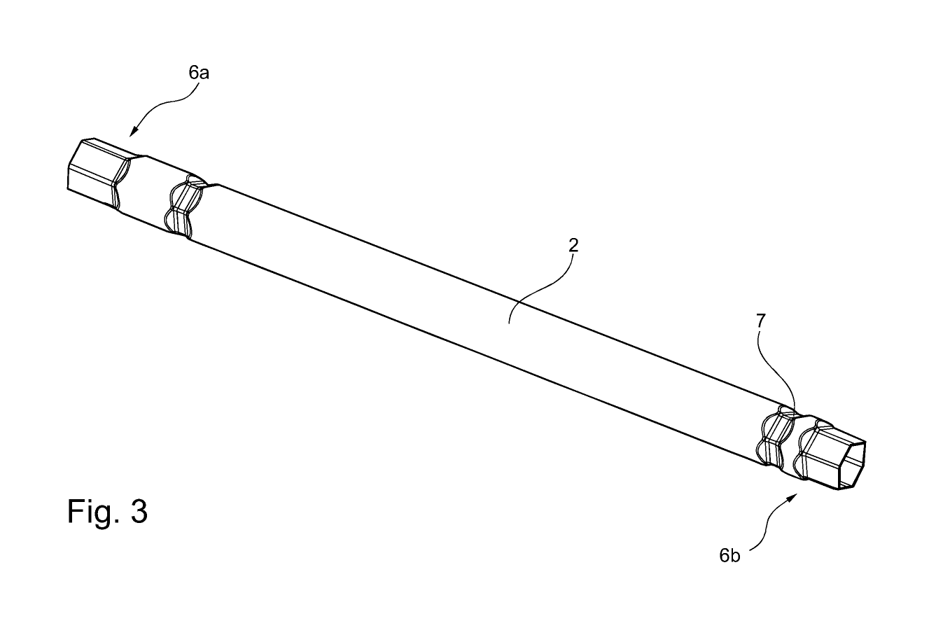

FIG. 4 A perspective view of a first reinforcing tube of the motor vehicle seat crossmember from FIG. 1 with a bearing section;

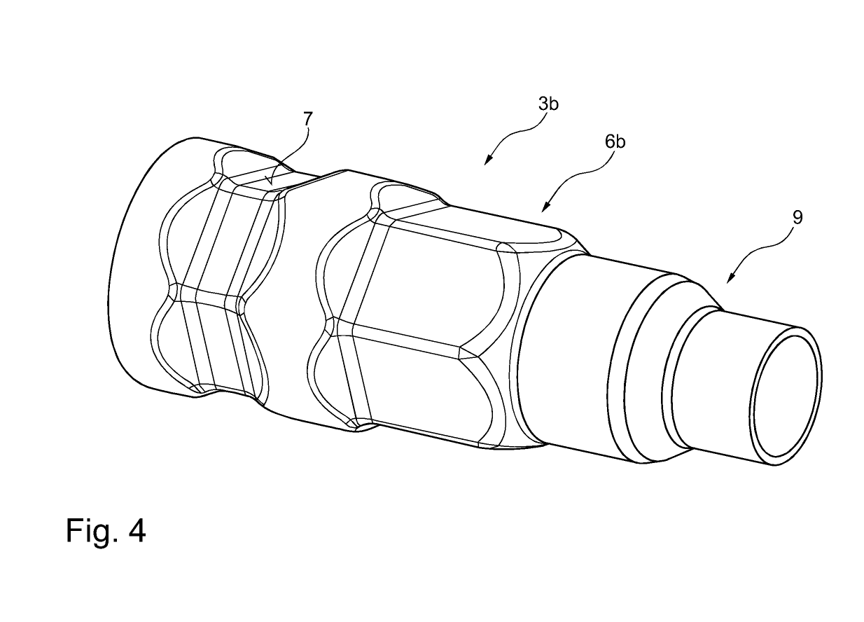

FIG. 5 A perspective view of a second reinforcing tube of the motor vehicle seat crossmember from FIG. 1 with a receptacle section for a torsion bar spring, and

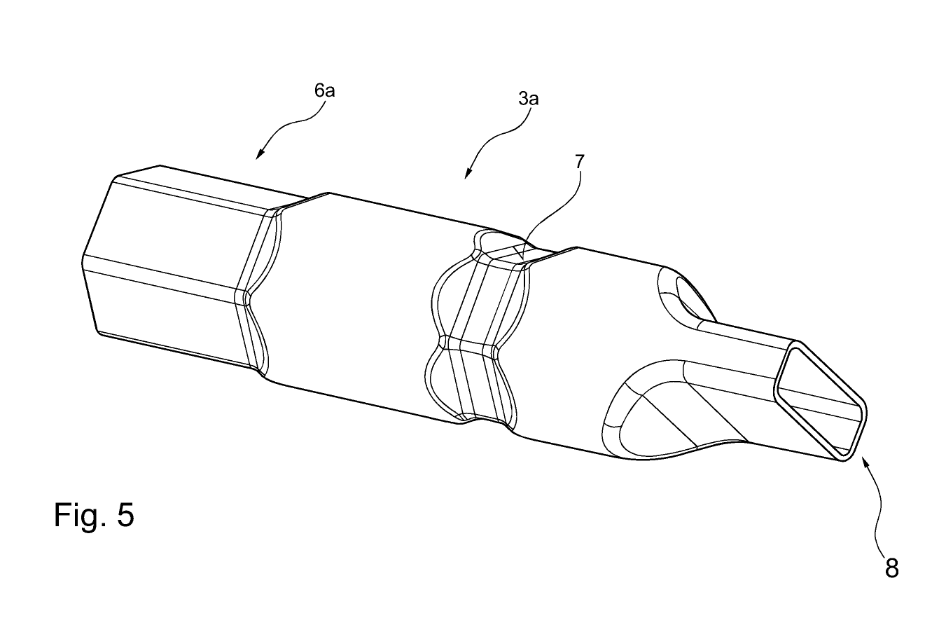

FIG. 6 A perspective view of the motor vehicle crossmember from FIG. 1 with an additional lever.

### DETAILED DESCRIPTION OF THE INVENTION

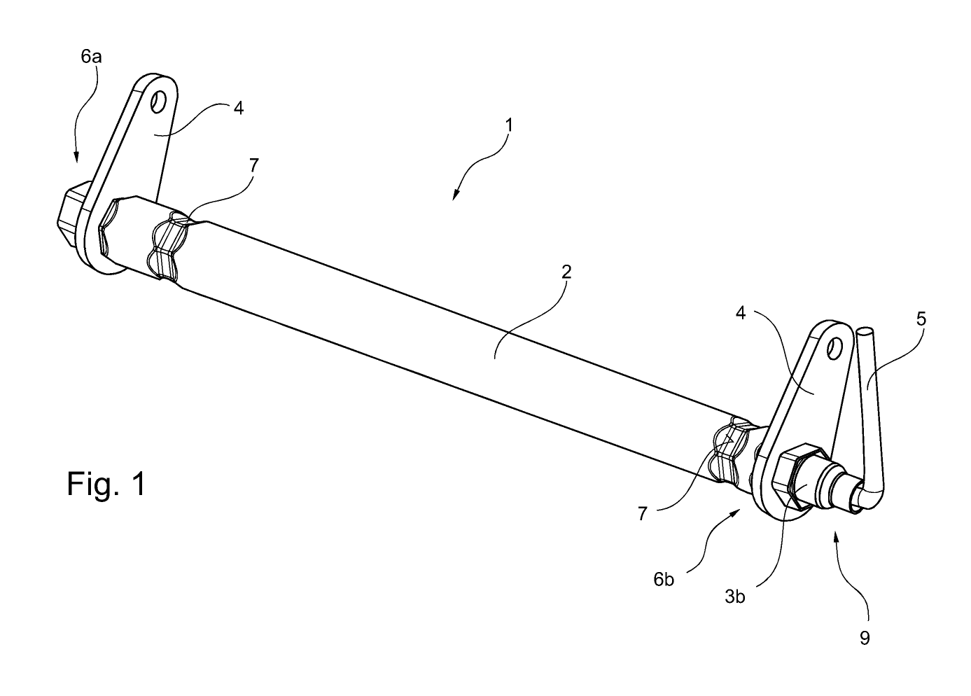

FIG. 1 shows a perspective view of an exemplary embodiment of a motor vehicle seat crossmember 1 that is formed from a tubular base body 2 and reinforcing tubes 3a, 3b shoved into the open ends of the tubular base body 2.

The reinforcing tubes 3a, 3b are inserted into the ends of the base body 2 and are connected to the base body 2 by means of joint deformation, especially cold formation. Together with the base body 2, the two different reinforcing tubes 3a, 3b jointly form a receptacle section 6a, 6b having a polygonal cross-section, as well as a tapering 7 that also has a polygonal cross-section.

In addition, the reinforcing tube 3a used to form a first receptacle section 6a has a flattened receptacle opening 8 to accommodate one end of a torsion bar spring 5 extending within the base body 2. The torsion bar spring 5 is arranged torsion-free in the receptacle opening 8, thus enabling intended use when the end of the torsion bar spring 5 opposite the receptacle opening 8 is correspondingly arranged in a torsion-free manner, wherein the torsion bar spring supports adjusting movements of a motor vehicle seat which is not shown here. The torsion bar spring 5 thereby extends in the area of the end of the base body 2 opposite the first receptacle section 6a through a second end of the base body 2, and the reinforcing tube 3b arranged in the area of the second end, different than the reinforcing tube 3a, has a bearing section 9 that extends beyond the end of the base body 2 and has a diameter which is up to 50% less than the diameter of the base body 2.

Levers 4 on the receptacle sections 6a, 6b serve to transmit torque to the motor vehicle seat crossmember 1 and have receptacle openings adapted to the receptacle sections 6a, 6b.

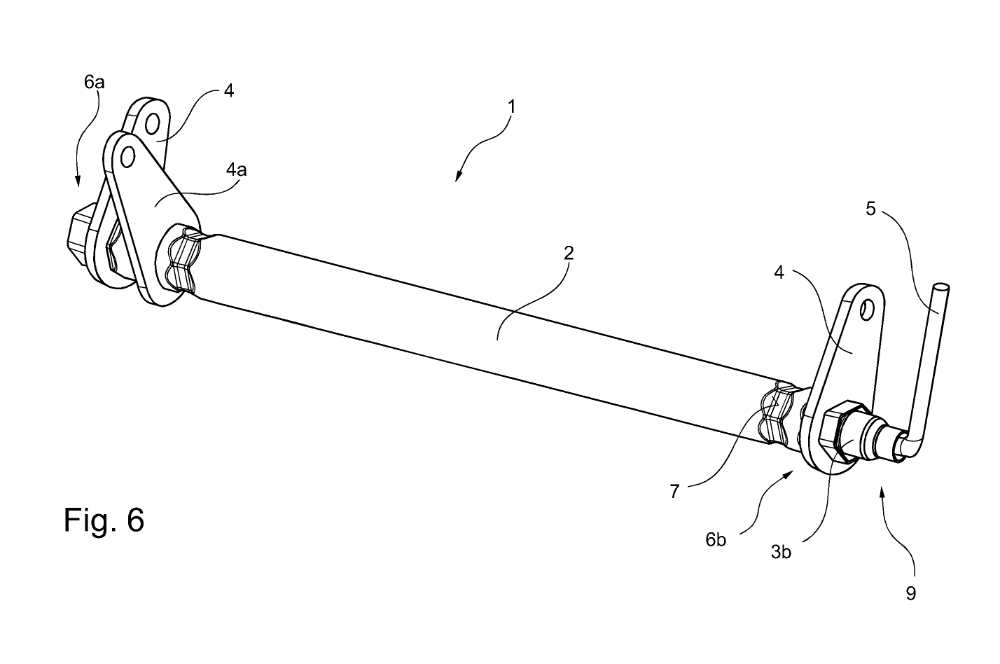

In the embodiment of the motor vehicle seat crossmember 1 shown in FIG. 6, another lever 4a is welded and thereby connected torsion-free to the base body 2 in the area of the reinforcing tube 3a, that is, in the cylindrical area between the tapering 7 and the receptacle section 6a.

Arranging the lever 4a in the extension of the reinforcing tube 3a already provided to accommodate the lever 4 allows particularly high torque to be transmitted between the two levers 4, 4a due to the strengthening effect of the reinforcing tube 3a. In addition, a particularly good weld connection of the lever 4a can be created in the area of the reinforcing tube 3a since the increase in volume of the wall thickness caused by the reinforcing tube 3a effectively prevents burn-through.

1. A motor vehicle seat crossmember comprising:
a tubular base body and
a receptacle section arranged on the base body for the torsion-free arrangement of a coupling element,
wherein the receptacle section has a reinforcing tube that is arranged coaxial to the base body and lies on its inner or outer surface, and a cross-section deviating from a circle that is produced by joint deformation, especially cold formation, of the base body and the reinforcing tube.

2. The motor vehicle seat crossmember according to claim 1, wherein the receptacle section has a polygonal cross-section.

3. The motor vehicle seat crossmember according to claim 1, wherein the receptacle section tapers opposite the direction in which the coupling element is pushed onto the receptacle section.

4. The motor vehicle seat crossmember according to claim 1, wherein the reinforcing tube is arranged within the base body, and particularly preferably in the area of one end of the base body.

5. The motor vehicle seat crossmember according to claim 1, comprising a tapering produced by joint deformation, especially cold formation, of the base body and reinforcing tube in an area different from the receptacle section.

6. The motor vehicle seat crossmember according to claim 1, wherein the reinforcing tube is designed for the torsion-free arrangement of one end of a torsion bar spring arranged within the base body.

7. The motor vehicle seat crossmember according to claim 1, wherein the reinforcing tube has a funnel-shaped receptacle opening for arranging the one end of the torsion bar spring.

8. The motor vehicle seat crossmember according to claim 1, wherein the reinforcing tube and the base body are integrally connected to each other, especially welded to each other.

9. The motor vehicle seat crossmember according to claim 1, wherein the reinforcing tube has a bearing section that extends beyond the end of the base body and has a diameter up to 50% less than the base body as a result of deformation, especially cold formation, of the reinforcing tube.

10. The motor vehicle seat crossmember according to claim 1, wherein one, preferably two, reinforcing tubes are arranged in the ends of the base body in each case.

11. The motor vehicle seat crossmember according to claim 1, wherein a reinforcing tube designed to receive one end of a torsion bar spring is arranged in the area of a first end of the base body, and a reinforcing tube with a bearing section extending beyond the end of the base body is arranged in the area of a second end of the base body.
